(19) United States
(12) Patent Application Publication
(10) Pub. No.: US 2026/0172340 A1
(43) Pub. Date: Jun. 18, 2026

(54) SYSTEM, METHOD, AND APPARATUS FOR CONTROLLING COMMUNICATION

(71) Applicants: HYUNDAI MOTOR COMPANY, Seoul (KR); KIA CORPORATION, Seoul (KR)

(72) Inventor: Dong Hyun Shin, Hwaseong-si (KR)

(73) Assignees: HYUNDAI MOTOR COMPANY, Seoul (KR); KIA CORPORATION, Seoul (KR)

(21) Appl. No.: 19/193,368

(22) Filed: Apr. 29, 2025

(30) Foreign Application Priority Data
Dec. 13, 2024 (KR) 10-2024-0186136

(51) Int. Cl. H04L 45/121; H04L 12/66; H04L 47/125

(52) U.S. Cl. CPC H04L 45/121; H04L 12/66; H04L 47/125

(57) ABSTRACT

A communication control apparatus includes a memory configured to store a program instruction. The communication control apparatus further includes a processor configured, by executing the program instruction, to transmit at least one data frame to a gateway control module according to a minimum separation time including a time interval for transmitting the at least one data frame. The processor is further configured to change the minimum separation time based on a communication load ratio related to a delay of routing. The processor is further configured to transmit the at least one data frame to the gateway control module according to the changed minimum separation time. Original data is divided into the at least one data frame. The gateway control module is configured to perform the routing.

### CROSS-REFERENCE TO RELATED APPLICATION

This application claims the benefit of and priority to Korean Patent Application No. 10-2024-0186136, filed in the Korean Intellectual Property Office on Dec. 13, 2024, the entire contents of which are incorporated herein by reference.

### TECHNICAL FIELD

The present disclosure relates to an apparatus, a system, and a method for controlling communication and more particularly relates to a technology for dividing and transmitting data.

### BACKGROUND

A vehicle network operates by transmitting and receiving data between various controllers. An electronic control device of a vehicle is required to be kept up to date through reprogramming such as firmware updates. In such a reprogramming process, it is important to transmit a large amount of data safely and efficiently. In particular, when transmitting a large amount of data, such as a software package, a security authentication key, and the like, it is sometimes difficult to transmit data at once due to limitations in the receiving buffer size of a vehicle controller. Accordingly, a scheme may be used to appropriately divide original data into data frames, transmit the data frames to a controller, and allow the controller to reassemble the data frames to reconstruct the original data.

Meanwhile, before reprogramming begins, a diagnostic device may transmit a disable normal message transmission (DNMT) message. Thus, all controllers of the vehicle may be put into a state where transmission and reception are restricted. However, some controllers may need to maintain a transmitting and receiving state for cooperative control. In this case, normal controller area network (CAN) messages and reprogramming messages may be mixed, and if the priority of the CAN message used for reprogramming is lower than that of the normal CAN message, there is a possibility that routing related to reprogramming may be missed.

A routing omission may result in some data not being received or being delayed during the process of transmitting a large amount of data. This may cause the entire reprogramming process to fail or delay the reprogramming time. Therefore, there is a need to provide a technique for improving the efficiency of segmented transmission and preventing routing delay and data loss. The subject matter described in this background section is intended to promote an understanding of the background of the disclosure and thus may include subject matter that is not already known to those of ordinary skill in the art.

### SUMMARY

The present disclosure has been made to solve the above-mentioned problems occurring in the prior art while advantages achieved by the prior art are maintained intact.

One aspect of the present disclosure provides an apparatus, a system, and a method for controlling communication capable of preventing routing from being missed by changing a minimum separation time based on a communication load ratio related to a routing delay.

Another aspect of the present disclosure provides an apparatus, a system, and a method for controlling communication capable of determining whether there is a risk of routing omission by determining a communication load ratio through counting related to a routing delay.

Still another aspect of the present disclosure provides an apparatus, a system, and a method for controlling communication capable of improving the success rate of updates by preventing failures in software updates that may occur due to a routing omission.

Still another aspect of the present disclosure provides an apparatus, a system, and a method for controlling communication capable of increasing efficiency in a test and evaluation process in a vehicle-related field by improving the success rate of software updates.

Still another aspect of the present disclosure provides an apparatus, a system, and a method for controlling communication capable of reducing the work time of a vehicle-related field by improving the success rate of software updates.

Still another aspect of the present disclosure provides an apparatus, a system, and a method for controlling communication capable of improving the efficiency of customer response service and after service (AS) maintenance by reducing the failure rate of controller updates using a diagnostic device in an AS center.

The technical problems to be solved by the present disclosure are not limited to the aforementioned problems. Any other technical problems not mentioned herein should be clearly understood from the following description by those having ordinary skill in the art to which the present disclosure pertains.

According to one aspect of the present disclosure, a communication control apparatus includes a memory configured to store a program instruction. The communication control apparatus further includes a processor configured, by executing the program instruction to transmit at least one data frame to a gateway control module according to a minimum separation time including a time interval for transmitting the at least one data frame. The processor is further configured to change the minimum separation time based on a communication load ratio related to a delay of routing. The processor is further configured to transmit the at least one data frame to the gateway control module according to the changed minimum separation time. Original data is divided into the at least one data frame. The gateway control module is configured to perform the routing.

According to an embodiment, the communication load ratio may increase as at least one of a time for which the routing is delayed, a number of times that the routing is delayed, or any combination thereof increases. The processor may increase the minimum separation time based on the communication load ratio exceeding a first threshold value. The first threshold value may be set to a value at which routing of the at least one data frame is determined to be delayed.

According to an embodiment, the processor may reduce the increased minimum separation time based on the communication load ratio being less than or equal to a second threshold value after increasing the minimum separation time. The second threshold value may be set to a value equal to or less than the first threshold value.

According to an embodiment, the processor may determine the communication load ratio based on at least one of a number of times that routing of the at least one data frame is delayed, a time for which the routing of the at least one data frame is delayed, or any combination thereof, received from the gateway control module.

According to an embodiment, the processor may transmit the at least one data frame to the gateway control module based on at least one of the minimum separation time, a capacity of the at least one data frame, a number of the at least one data frame that is able to be transmitted at one time, a state of the communication control apparatus regarding whether transmission of the at least one data frame is possible, or any combination thereof.

According to an embodiment, the processor may transmit the at least one data frame to the gateway control module according to the minimum separation time of a controller area network (CAN) communication protocol.

According to an embodiment, the processor may change the minimum separation time based on a time taken for routing of the at least one data frame to be completed by the gateway control module.

According to another aspect of the present disclosure, a system for controlling communication includes a communication control apparatus configured to transmit at least one data frame to a gateway control module according to a minimum separation time. The communication control apparatus is further configured to change the minimum separation time based on the information about the delay. The system for controlling communication further includes the gateway control module configured to perform routing. The gateway control module is further configured to transmit the information about the delay to the communication control apparatus based on the delay occurring in routing of the at least one data frame. Original data is divided into the at least one data frame.

According to an embodiment, the gateway control module may identify the information about the delay including at least one of a number of times that routing of the at least one data frame is delayed, a time for which the routing of the at least one data frame is delayed, or any combination thereof, based on the delay occurring in the routing of the at least one data frame.

According to an embodiment, the gateway control module may repeatedly transmit the information about the delay to the communication control apparatus at a preset cycle until the routing of the at least one data frame included in the data is completed.

According to an embodiment, the communication control apparatus may determine a communication load ratio based on information about the delay of the routing. The communication control apparatus may increase the minimum separation time based on the communication load ratio exceeding a first threshold value. The first threshold value may be set to a value at which routing of the at least one data frame is determined to be delayed.

According to an embodiment, the system may further include a target control module that receives the at least one data frame from the gateway control module. The gateway control module may transmit a disable normal message transmission (DNMT) message for deactivating normal transmission of a message to the target control module. Alternatively, the gateway control module may transmit an enable normal message transmission (ENMT) message for activating normal transmission of the message to the target control module.

According to an embodiment, the system may further include a target control module configured to receive the at least one data frame from the gateway control module. The target control module may transmit information about the minimum separation time according to requirements of the target control module to the communication control apparatus for controlling communication. The communication control apparatus may transmit the at least one data frame to the gateway control module based on the information about the minimum separation time.

According to still another aspect of the present disclosure, a method of controlling communication includes transmitting, by a processor, at least one data frame to a gateway control module according to a minimum separation time including a time interval for transmitting the at least one data frame. The method of controlling communication further includes changing, by the processor, the minimum separation time based on a communication load ratio related to a delay of routing. The method of controlling communication further includes transmitting, by the processor, the at least one data frame to the gateway control module according to the changed minimum separation time.

According to an embodiment, changing the minimum separation time may include increasing, by the processor, the minimum separation time based on the communication load ratio exceeding a first threshold value. The first threshold value may be set to a value at which routing of the at least one data frame is determined to be delayed.

According to an embodiment, the changing of the minimum separation time may include reducing, by the processor, the increased minimum separation time based on the communication load ratio being less than or equal to a second threshold value after increasing the minimum separation time. The second threshold value may be set to a value equal to or less than the first threshold value.

According to an embodiment, the method may further include determining, by the processor, the communication load ratio based on at least one of a number of times that routing of the at least one data frame is delayed, a time for which the routing of the at least one data frame is delayed, or any combination thereof, received from the gateway control module.

According to an embodiment, changing the minimum separation time may include transmitting, by the processor, the at least one data frame to the gateway control module based on at least one of the minimum separation time, a capacity of the at least one data frame, a number of the at least one data frame that is able to be transmitted at one time, a state of the apparatus regarding whether transmission of the at least one data frame is possible, or any combination thereof.

According to an embodiment, changing the minimum separation time may include transmitting, by the processor, the at least one data frame to the gateway control module according to the minimum separation time of a controller area network (CAN) communication protocol.

According to an embodiment, changing the minimum separation time may include changing, by the processor, the minimum separation time based on a time taken for routing of the at least one data frame to be completed by the gateway control module.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating an apparatus for controlling communication according to an embodiment of the present disclosure;

FIG. 2 is a block diagram illustrating a system for controlling communication including an apparatus for controlling communication according to an embodiment of the present disclosure;

FIG. 3 is a diagram illustrating that routing omission occurs in some of the data frames transmitted by an apparatus for controlling communication according to an embodiment of the present disclosure;

FIG. 4 is a diagram illustrating that a data frame transmitted by an apparatus for controlling communication is routed to a target control module via a gateway control module according to an embodiment of the present disclosure;

FIG. 5 is a flowchart illustrating a system for controlling communication when a communication load ratio is high according to an embodiment of the present disclosure;

FIG. 6 is a flowchart illustrating a system for controlling communication when a communication load ratio is low according to an embodiment of the present disclosure;

FIG. 7 is a flowchart illustrating a method for controlling communication according to an embodiment of the present disclosure;

FIG. 8 is a flowchart illustrating that a method for controlling communication changes a minimum separation time according to a routing delay time according to an embodiment of the present disclosure; and

FIG. 9 is a diagram illustrating a computing system related to an apparatus, a system, and a method for controlling communication according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent components are specified by the identical numerals even when the components are displayed on other drawings. Further, in describing the embodiment of the present disclosure, a detailed description of the related known configuration or function has been omitted when it is determined that the detailed description interferes with the understanding of the embodiment of the present disclosure.

Terms, such as first, second, A, B, (a), (b), or the like may be used to describe components of the present disclosure. The terms are provided only to distinguish the elements from other elements, and the essences, sequences, orders, and numbers of the elements are not limited by the terms. In addition, the expression such as “at least one of A, B, C, or any combination thereof” may include A or B or C or any combination thereof such as AB, BC, AC or ABC.

In addition, unless defined otherwise, all terms used herein, including technical or scientific terms, have the same meanings as those generally understood by those having ordinary skill in the art to which the present disclosure pertains. The terms defined in the generally used dictionaries should be construed as having the meanings that are consistent with the meanings of the contexts of the related technologies. The terms should not be construed as ideal or excessively formal meanings unless clearly defined in the present disclosure. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

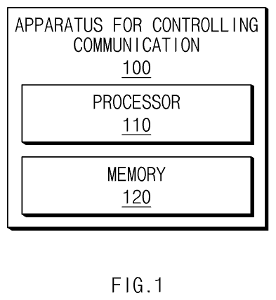

Hereinafter, embodiments of the present disclosure are described in detail with reference to FIGS. 1-9.

FIG. 1 is a block diagram illustrating an apparatus for controlling communication according to an embodiment of the present disclosure.

Referring to FIG. 1, an apparatus for controlling communication 100 according to an embodiment of the present disclosure may be implemented inside a vehicle. In this case, the apparatus for controlling communication 100 may be formed integrally with internal control devices of the vehicle or may be implemented as a separate device and connected to the control devices of the vehicle through a separate connection device.

According to an embodiment, the apparatus for controlling communication 100 may include a processor 110 and a memory 120. The configuration of the apparatus for controlling communication 100 illustrated in FIG. 1 is illustrative, and embodiments of the present disclosure are not limited thereto. For example, the apparatus for controlling communication 100 may further include components not shown in FIG. 1.

According to an embodiment, the memory 120 may store commands or data. For example, the memory 120 may store one instruction or two or more instructions configured to, when executed by the processor 110, allow the apparatus for controlling communication 100 to perform various operations.

According to an embodiment, the memory 120 may be implemented as a single chipset with the processor 110 and may store various information related to the apparatus for controlling communication 100. For example, the memory 120 may store information about the operation history of the processor 110.

According to an embodiment, the memory 120 may include a non-volatile memory (e.g., a read only memory, i.e., ROM) and a volatile memory (e.g., a random access memory, i.e., RAM). For example, a threshold value for minimum separation time may be stored in the memory 120.

According to an embodiment, the processor 110 may transmit at least one data frame into which data is divided, to a gateway control module that performs routing.

For example, it may be difficult to receive large data, such as software packages or security authentication keys, at once due to a limitation, such as a size of a receiving buffer, and the like. In this case, the original data may be divided into two or more data frames. The processor 110 may transmit two or more divided data frames to the gateway control module. Thereafter, the two or more divided data frames may be reassembled to reconstruct the original data.

According to an embodiment, the gateway control module may manage data communication between multiple electronic control units (ECUs) within a vehicle. The gateway control module may perform efficient routing, during the transmission of large amounts of data. Several controllers within a vehicle may include target control modules.

According to an embodiment, the gateway control module may route at least one data frame received from the processor 110.

According to an embodiment, routing may mean the process of setting up a path from a transmission side to a reception side to transmit data through a vehicle network and transmitting or managing data. This process may be performed by considering the data priority, transmission speed, and communication load ratio.

According to an embodiment, the processor 110 may transmit at least one data frame to the gateway control module according to a minimum separation time (Stmin) including a time interval for transmitting the at least one data frame.

According to an embodiment, the minimum separation time may include a parameter indicating a minimum time interval set between consecutive frames (CF) when dividing a large amount of data into data frames and transmitting the data frame. This may be used to ensure the stability and efficiency of data transmission under a communication protocol in a vehicle network, such as a controller area network (CAN).

According to an embodiment, as the minimum separation time increases, the latency between data frames may increase and the data transmission rate may be slowed down. For example, as the minimum separation time increases, the data reception side may have sufficient time to process the data, and thus the chance of missing data frames may be reduced. Accordingly, data may be transmitted stably even in a congested network situation.

According to an embodiment, as the minimum separation time decreases, the smaller the split transmission period, the shorter the waiting time between data frames, and the faster the data transmission speed. For example, the smaller the split transmission period, the smaller the latency between data frames. Thus, tasks, such as reprogramming, may be quickly completed. However, continuous data transmission may increase the likelihood of network collisions or congestion.

According to an embodiment, the processor 110 may transmit at least one data frame to the gateway control module according to a preset minimum separation time.

For example, the preset minimum separation time may include a default value set in the system.

For example, the preset minimum separation time may include a minimum separation time according to requirements of the target control module. As a specific example, the requirements of the target control module may include specifications of the target control module. In other words, the minimum separation time according to the requirements of the target control module may include a minimum separation time in which the target control module may normally receive data.

According to an embodiment, the processor 110 may change the minimum separation time based on a communication load ratio related to a delay of routing.

According to an embodiment, the communication load ratio may include an indicator representing the degree of congestion of data communication within the network. For example, the communication load ratio may be calculated based on factors related to the amount of data that is to be processed on the network during a specific time. The communication load ratio may be used to quantitatively evaluate data transmission delay, data processing volume, network congestion, and the like and may perform an important function for ensuring system efficiency and stability.

According to an embodiment, the processor 110 may determine the communication load ratio based on at least one of the time for which routing is delayed, the number of times that routing is delayed, or any combination thereof, received from the gateway control module.

For example, the gateway control module may count at least one of the time for which the routing of a data frame is delayed, the number of times that the routing of a data frame is delayed, or any combination thereof.

The gateway control module may transmit at least one of a counted value for the time for which the routing is delayed, a counted value for the number of times that the routing is delayed, or any combination thereof to the processor 110 of the apparatus for controlling communication.

The processor 110 may determine the communication load ratio based on the counted value received from the gateway control module.

For example, the communication load ratio may increase as at least one of the time for which the routing is delayed, the number of times that the routing is delayed, or any combination thereof increases. To the contrary, the communication load ratio may be reduced as at least one of the time for which the routing is delayed, the number of times that the routing is delayed, or any combination thereof.

According to an embodiment, the processor 110 may increase the minimum separation time when the communication load ratio is high. For example, the processor 110 may determine that when the communication load ratio is high, there is a high possibility that a routing delay will occur. When a routing delay occurs, a data frame being routed may be missed.

Accordingly, the processor 110 may increase the minimum separation time to prevent data frame loss and transmit the data frame with the increased minimum separation time to the gateway control module. The gateway control module may route data frames based on the increased minimum separation time.

According to an embodiment, the processor 110 may reduce the minimum separation time when the communication load ratio is low. For example, the processor 110 may determine that there is a low possibility of routing delay when the communication load ratio is low.

Accordingly, the processor 110 may reduce the minimum separation time to increase the transmission speed of the data frame and transmit, to the gateway control module, the data frame to which the reduced minimum separation time is applied. The gateway control module may route data frames based on the reduced minimum separation time.

According to an embodiment, the processor 110 may increase the minimum separation time based on the communication load ratio exceeding the first threshold value. The first threshold value may be set to a value at which the routing of at least one data frame is determined to be delayed.

For example, the processor 110 may determine that there is a possibility that a data frame may be missed during the routing process when transmitting the data frame at the minimum separation time, which is currently applied in a situation where the communication load ratio exceeds the first threshold value.

According to an embodiment, the processor 110 may variably apply the minimum separation time when transmitting a data frame to the gateway control module.

According to an embodiment, the processor 110 may transmit at least one data frame to the gateway control module according to the changed minimum separation time. For example, when the minimum separation time is changed based on the communication load ratio, the processor 110 may transmit at least one data frame to the gateway control module at the changed minimum separation time.

According to an embodiment, the processor 110 may change the minimum separation time in the process of transmitting at least one data frame to the gateway control module. In this case, the minimum separation time applied to one data frame may be different from the minimum separation time applied to another data frame.

According to an embodiment, the processor 110 may distinguish between a section with a high communication load rate and a section with a low communication load ratio. The processor 110 may variably apply the minimum separation time based on the communication load ratio. For example, the processor 110 may to transmit a data frame by increasing the minimum separation time only in a section where the communication load ratio.

According to an embodiment, after increasing the minimum separation time, the processor 110 may reduce the increased minimum separation time based on the communication load ratio being less than or equal to the second threshold value.

For example, the second threshold value may be set to a value equal to or less than the first threshold value. The second threshold value may be set to a value at which routing of data frames is no longer delayed.

According to an embodiment, the processor 110 may continuously determine the communication load ratio during the process of transmitting a data frame. The processor 110 may change the minimum separation time in real time according to changes in the communication load ratio.

For example, in a situation where the processor 110 transmits a data frame at the increased minimum separation time, if it is determined that routing is no longer delayed, the processor 110 may reduce the minimum separation time again to improve transmission efficiency of the data frame.

According to an embodiment, the processor 110 may transmit at least one data frame to the gateway control module based on at least one of the minimum separation time, a capacity of the at least one data frame, the number of the at least one data frame that is able to be transmitted at one time, a state of the apparatus for controlling communication regarding whether transmission of the at least one data frame is possible, or any combination thereof.

For example, the processor 110 may transmit at least one data frame to the gateway control module at the preset minimum separation time.

For example, the processor 110 may transmit at least one data frame to the gateway control module, by considering the capacity of at least one data frame. As a specific example, if the capacity of the data frame is large, the data frame may be divided into frames having a smaller size and transmitted to the gateway control module.

For example, the processor 110 may transmit at least one data frame to the gateway control module, by considering the number of at least one data frame that may be transmitted at one time. The number of data frames that may be transmitted at one time (block size: BS) may include the maximum number of data frames that may be transmitted at one time.

For example, the processor 110 may transmit at least one data frame to the gateway control module based on the state, of the apparatus for controlling communication, regarding whether at least one data frame is capable of being transmitted. As a specific example, the state of the apparatus for controlling communication may include a state in which data frames are capable of being normally transmitted and received or a state in which transmission and reception of data frames are restricted.

According to an embodiment, the processor 110 may transmit the at least one data frame to the gateway control module according to the minimum separation time of a controller area network (CAN) communication protocol.

The CAN communication protocol may include a communication protocol that may quickly and efficiently exchange data between multiple electronic control devices within a vehicle.

According to an embodiment, the processor 110 may change the minimum separation time based on a time taken for routing of at least one data frame to be completed by the gateway control module.

For example, the processor 110 may change the minimum separation time in advance to prevent loss of routed data frames. In other words, the processor 110 may determine when to change the minimum separation time by considering the time taken for routing of at least one data frame to be completed by the gateway control module.

Meanwhile, a vehicle may include a plurality of electronic control units (ECUs) that each performs different functions to control the operations of the engine and other devices according to a plurality of driving conditions. In particular, the ECUs may perform operations according to algorithms that are predetermined at the time of vehicle release. Therefore, the ECUs may be reprogrammed to improve functionality and performance and correct software errors.

In other words, reprogramming may refer to an operation of upgrading the software of an electronic control unit (ECU). More specifically, the reprogramming may refer to an operation of upgrading software for the purpose of upgrading the functions of a vehicle and an ECU and correcting errors in the software of the ECU. Therefore, reprogramming in the present disclosure may be mainly described as representing all operations for upgrading the software of the ECU included in a vehicle.

In relation to reprogramming, the apparatus 100 for controlling communication may use the CAN communication protocol as an in-vehicle communication network. In this case, the protocol data may contain at least one data frame. As a specific example, protocol data may be divided into a single frame where the size of a transmission block does not exceed 8 bytes and a consecutive frame, which is divided into multiple CAN frames where the size of a transmission block exceeds 8 bytes for transmission.

The apparatus 100 for controlling communication may identify information about the protocol data block size to be received through consecutive frames and a minimum separation time indicating the transmission time period of consecutive frames for the data block.

In this case, the time required for reprogramming may be determined based on the minimum separation time. For example, if the minimum separation time is reduced to a minimum value, protocol data that the target control module is to receive through consecutive frames may be missed. In more detail, when the minimum separation time is reduced, non-transmitted protocol data may be overwritten by newly received protocol data, so that the non-transmitted protocol data may be missed. Therefore, it is necessary to variably control the minimum separation time to prevent protocol data for reprogramming from being missed.

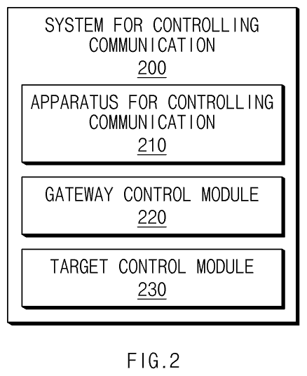

FIG. 2 is a block diagram illustrating a system for controlling communication including an apparatus for controlling communication according to an embodiment of the present disclosure.

According to an embodiment, a system 200 for controlling communication may include at least one of an apparatus for controlling communication 210, a gateway control module 220, a target control module 230, or any combination thereof.

The configuration of the system 200 for controlling communication shown in FIG. 2 is illustrative, and embodiments of the present disclosure are not limited thereto. For example, the system 200 for controlling communication may further include components not shown in FIG. 2.

According to an embodiment, the apparatus for controlling communication 210 may transmit at least one data frame into which data is divided.

According to an embodiment, the gateway control module 220 may perform routing. For example, the gateway control module 220 may route a data frame received from the apparatus for controlling communication.

According to an embodiment, the apparatus for controlling communication 210 may transmit at least one data frame to the gateway control module 220 according to a minimum separation time.

According to an embodiment, the target control module 230 may receive at least one data frame from the gateway control module 220. For example, the gateway control module 220 may route the at least one data frame to the target control module 230.

According to an embodiment, the gateway control module 220 may transmit information about a delay to the apparatus for controlling communication 210 based on whether the delay occurs in the routing of at least one data frame.

The information about the delay may include at least one of time for which the routing is delayed, the number of times that the routing is delayed, or any combination thereof.

Situations in which routing delay occurs may include situations in which routing delay is likely to occur. For example, a situation in which a routing delay occurs may include a situation in which a routing delay is likely to occur if data frames are continuously transmitted at the currently applied minimum separation time.

According to an embodiment, the gateway control module 220 may route at least one data frame to the target control module 230. In this case, the data routed by the gateway control module 220 may include general data or data frames related to reprogramming. Data frames related to general data and reprogramming may have different routing priorities.

According to an embodiment, if excessive general data is routed within a channel in a routing process, a delay may occur in the routing of data frames related to reprogramming according to the routing priority. If the delay is long and the minimum separation time of the data frame related to reprogramming is set too low, there may be a possibility that the corresponding data frame is deleted from a buffer, and thus routing is missed. The missed routing may include a case where routing is performed with missing a data frame.

According to an embodiment, the apparatus for controlling communication 210 may change the minimum separation time based on the information about the delay of routing.

According to an embodiment, the apparatus for controlling communication 210 may determine the communication load ratio based on the information about the delay of routing.

According to an embodiment, the apparatus for controlling communication 210 may increase the minimum separation time based on the communication load ratio exceeding the first threshold value.

The first threshold value may be set to a value at which routing of at least one data frame is determined to be delayed. In this case, it may be understood that the first threshold value may be the same as the first threshold value described in the description of FIG. 1.

According to an embodiment, the gateway control module 220 may identify the information about the delay including at least one of the number of times that routing of the at least one data frame is delayed, the time for which the routing of the at least one data frame is delayed, or any combination thereof, based on the delay occurring in the routing of the at least one data frame.

For example, the gateway control module 220 may count the number of times that routing of at least one data frame is delayed. The gateway control module 220 may calculate a counting value for the number of times that routing is delayed.

For example, the gateway control module 220 may count the time for which routing of at least one data frame is delayed. The gateway control module 220 may calculate a counting value for the time for which routing is delayed.

For example, the gateway control module 220 may transmit a counting value for the number of times that routing of at least one data frame is delayed, or for the time that routing of at least one data frame is delayed, to the apparatus for controlling communication 210.

According to an embodiment, the gateway control module 220 may repeatedly transmit information about a delay to the apparatus for controlling communication 210 at a preset cycle until routing of at least one data frame included in data is completed.

For example, the gateway control module 220 may transmit information about a delay to the apparatus for controlling communication 210 whenever a data frame is routed.

For example, the gateway control module 220 may transmit information about a delay to the apparatus for controlling communication 210 whenever a data frame is routed.

For example, the gateway control module 220 may no longer transmit information about a delay to the apparatus for controlling communication 210 when routing of at least one data frame included in data is completed. In other words, if a plurality of data frames obtained by dividing one original data is all routed, the transmission of the information about a delay may also be interrupted.

According to an embodiment, the gateway control module 220 may transmit a disable normal message transmission (DNMT) message for deactivating normal transmission of messages to the target control module 230. The target control module 230 that receives the DNMT message may temporarily suspend general data transmission and reception such that important data, such as reprogramming data, may be processed with priority.

According to an embodiment, the gateway control module 220 may transmit an enable normal message transmission (ENMT) message for activating normal transmission of messages to the target control module 230. The target control module 230 that receives the ENMT message may release the restricted transmission and reception of messages in a DNMT state and may resume general data transmission and reception.

According to an embodiment, the gateway control module 220 may ensure smooth transmission of reprogramming data by dynamically adjusting DNMT messages and ENMT messages in consideration of the system status and network load. In addition, when cooperative control of the target control module 230 is required, it may be adjusted such that normal message transmission and reception may be maintained.

According to an embodiment, the target control module 230 may transmit the information about the minimum separation time according to the requirements of the target control module 230 to the apparatus for controlling communication 210. For example, the requirements of the target control module 230 may include specifications of the target control module 230.

For example, the information about the minimum separation time according to the requirements of the target control module 230 may include technical conditions such as the maximum capacity of data processed by the target control module 230, the transmission rate, or the supportable protocol.

According to an embodiment, the apparatus for controlling communication may transmit at least one data frame to the gateway control module based on the information about the minimum separation time according to the requirements of the target control module 230.

The apparatus for controlling communication 210 may transmit data frames efficiently and stably by transmitting data frames at the minimum separation time according to the requirements of the target control module 230.

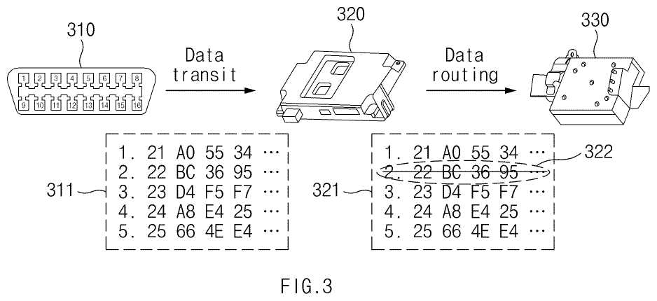

FIG. 3 is a diagram illustrating that routing omission occurs in some of the data frames transmitted by an apparatus for controlling communication according to an embodiment of the present disclosure.

According to an embodiment, an apparatus for controlling communication 310 may transmit data to a gateway control module 320. For example, the apparatus for controlling communication 310 may transmit, to a gateway control module 320, a plurality of data frames 311 into which data is divided.

According to an embodiment, the gateway control module 320 may route data to a target control module 330. For example, the gateway control module 320 may route a plurality of data frames 321 received from the apparatus for controlling communication 310 to the target control module 330.

According to an embodiment, during the process of routing data to the target control module 330 by the gateway control module 320, some data may be missed. For example, the gateway control module 320 may omit routing of some data frames 322 among the plurality of data frames 321 received from the apparatus for controlling communication 310.

For example, if the routing of data on reprogramming is missed, the entire reprogramming process may fail, or the reprogramming time may be delayed.

Therefore, referring to FIG. 3, a solution is required to solve problems related to routing delay and data loss.

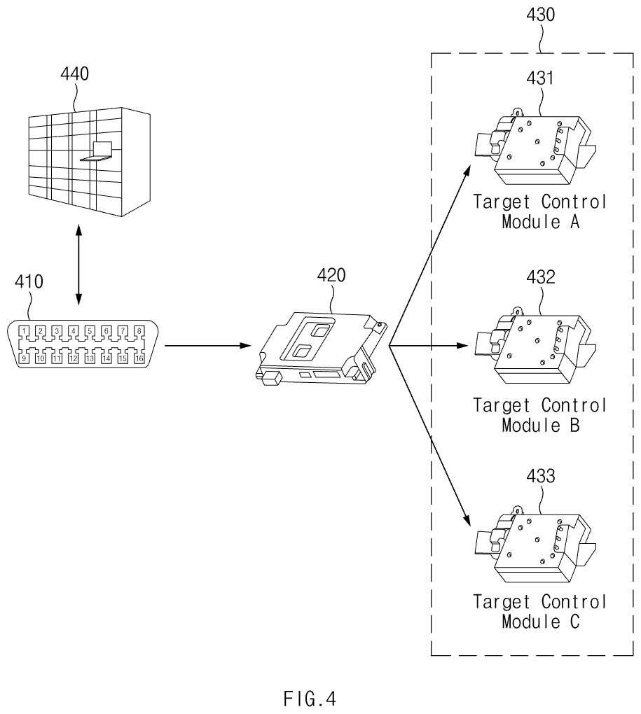

FIG. 4 is a diagram illustrating that a data frame transmitted by an apparatus for controlling communication is routed to a target control module via a gateway control module according to an embodiment of the present disclosure.

According to an embodiment, an apparatus for controlling communication 410 may receive data from a server 440 or transmit a command related to data transmission and reception. For example, the server 440 may include a software update management system (SUMS) server that authenticates, manages, and distributes software update packages.

According to an embodiment, the apparatus for controlling communication 410 may receive information about reprogramming data from the server 440. For example, the apparatus for controlling communication 410 may receive information about software update packages from the server 440.

According to an embodiment, the apparatus for controlling communication 410 may transmit data to the gateway control module 420. For example, the apparatus for controlling communication 410 may transmit, to the gateway control module 420, at least one data frame in which a large amount of original data is divided.

According to an embodiment, the apparatus for controlling communication 410 may transmit a data frame to the gateway control module 420 by using CAN communication. For example, the apparatus for controlling communication 410 may transmit a data frame to the gateway control module 420 by using diagnostic CAN (D-CAN) communication. The D-CAN communication may be used to transmit data on OBD-II diagnostics, error code management, or ECU reprogramming.

According to an embodiment, the gateway control module 420 may route data to a plurality of target control modules 430. For example, the gateway control module 420 may route, to the plurality of target control modules 430, at least one data frame obtained by dividing a large amount of original data. The plurality of target control modules 430 may include a target control module A 431, a target control module B 432, and a target control module C 433.

According to an embodiment, the gateway control module 420 may route a data frame to the plurality of target control modules 430 by using CAN communication. For example, the gateway control module 420 may route a data frame by using chassis CAN (C-CAN) communication, powertrain CAN (P1-CAN) communication, or multi-media CAN (M-CAN) communication. The CAN (C-CAN) communication may be used to transmit data on the chassis of a vehicle. The P1-CAN communication may be used to transmit data on to the powertrain (engine and transmission). The M-CAN communication may be used to transmit data on multimedia or convenience functions in a vehicle.

According to an embodiment, the gateway control module 420 may transmit the same data to the plurality of target control modules 430 or may transmit different data to each of the plurality of target control modules 430.

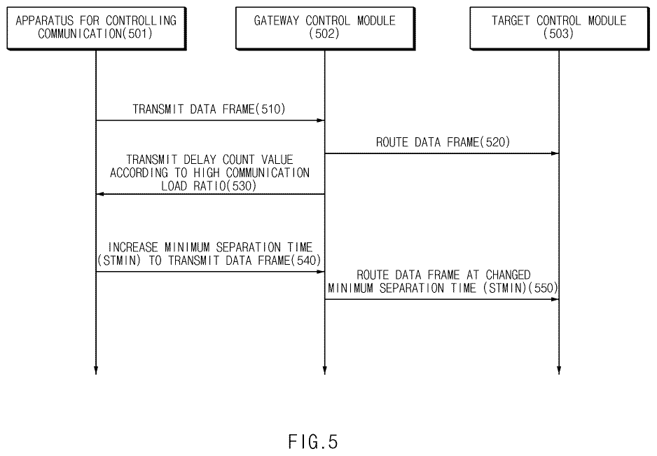

FIG. 5 is a flowchart illustrating a system for controlling communication when a communication load ratio is high according to an embodiment of the present disclosure.

According to an embodiment, in 510, an apparatus for controlling communication 501 may transmit a data frame to a gateway control module 502. The data frame may include data frames obtained by dividing a large amount of original data. In detail, the data frame may include a data frame related to reprogramming. As a specific example, if reprogramming of a specific controller begins, the apparatus for controlling communication 501 may transmit a package of the target controller downloaded from a server in advance to the gateway control module 502.

According to an embodiment, the gateway control module 502 may dynamically adjust a DNMT message and an ENMT message in consideration of the state of the system and the network load.

According to an embodiment, in 520, the gateway control module 502 may route the data frame received from the apparatus for controlling communication 501 to a target control module 503.

According to an embodiment, the gateway control module 502 may identify the information about a delay including at least one of the number of times that routing of the data frame is delayed, the time for which the routing of the data frame is delayed, or any combination thereof in the process of routing the data frame to the target control module 503.

For example, the gateway control module 502 may count the number of times that routing of the data frame is delayed. The gateway control module 502 may calculate a counting value for the number of times that routing is delayed.

For example, the gateway control module 502 may count the time for which routing of a data frame is delayed. The gateway control module 502 may calculate a counting value for the time for which routing is delayed.

According to an embodiment, in 530, the gateway control module 502 may transmit, to the apparatus for controlling communication 501, at least one of a counting value for the number of times routing is delayed, a counting value for the time for which routing is delayed, or any combination thereof.

According to an embodiment, the apparatus for controlling communication 501 may determine the communication load ratio based on at least one of the counting value for the number of times routing is delayed, the counting value for the time for which routing is delayed, or any combination thereof.

For example, if a counting value for the number of times routing is delayed or a counting value for the time for which routing is delayed exceeds a preset reference, the apparatus for controlling communication 501 may determine that the communication load ratio is high. If the communication load is high, there may be omission in routing of the gateway control module 502.

According to an embodiment, in 540, the apparatus for controlling communication 501 may increase the minimum separation time if the communication load ratio is high. In 540, the apparatus for controlling communication 501 may transmit a data frame to the gateway control module 502 at the increased minimum separation time. As the minimum separation time is increased, the latency between data frames may increase and the data transmission rate may slow down.

According to an embodiment, in 550, the gateway control module 502 may route the data frame to the target control module 503 at the increased minimum separation time.

Referring to FIG. 5 according to an embodiment, the apparatus for controlling communication 501 may increase the minimum separation time according to a high communication load ratio, and the gateway control module 502 may route data frames at the increased minimum separation time. Thus, data frames may be prevented from being missed during the routing process.

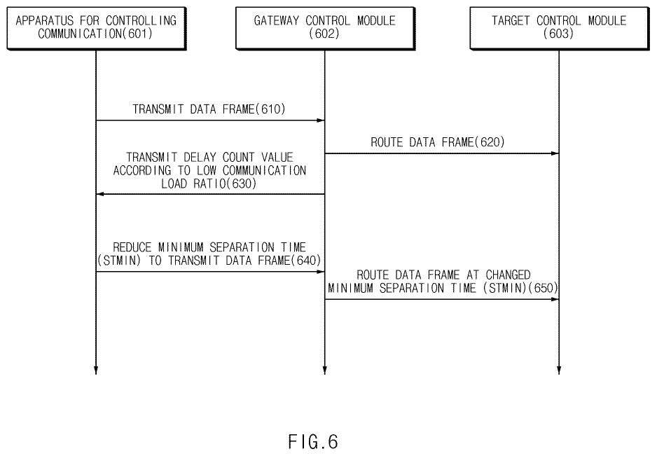

FIG. 6 is a flowchart illustrating a system for controlling communication when a communication load ratio is low according to an embodiment of the present disclosure.

According to an embodiment, in 610, an apparatus for controlling communication 601 may transmit a data frame to a gateway control module 602. The data frame may include data frames obtained by dividing a large amount of original data.

According to an embodiment, in 620, the gateway control module 602 may route the data frame received from the apparatus for controlling communication 601 to a target control module 603.

According to an embodiment, the gateway control module 602 may identify the information about a delay including the number of times that routing of the data frame is delayed in the process of routing the data frame to the target control module 603.

For example, the gateway control module 602 may calculate a counting value for the number of times that routing is delayed.

For example, the gateway control module 602 may calculate a counting value for the time for which routing is delayed.

According to an embodiment, in 630, the gateway control module 602 may transmit at least one of a counting value for the number of times routing is delayed, a counting value for the time for which routing is delayed, or any combination thereof to the apparatus for controlling communication 601.

According to an embodiment, the apparatus for controlling communication 601 may determine the communication load ratio based on at least one of the counting value for the number of times routing is delayed, the counting value for the time for which routing is delayed, or any combination thereof.

For example, if a counting value for the number of times routing is delayed or a counting value for the time for which routing is delayed is equal to or less than a preset reference, the apparatus for controlling communication 601 may determine that the communication load ratio is low. If the communication load ratio is low, there may no longer be any omissions in the routing of the gateway control module 602. Accordingly, it may be necessary to improve the transmission efficiency of data frames by reducing the minimum separation time again.

According to an embodiment, in 640, the apparatus for controlling communication 601 may reduce the minimum separation time if the communication load ratio is low. In 640, the apparatus for controlling communication 601 may transmit a data frame to the gateway control module 602 at the reduced minimum separation time. As the minimum separation time is reduced, the latency between data frames may decrease and the data transmission rate may be faster.

According to an embodiment, the reduced minimum separation time may be equal to the minimum separation time according to the requirements of the existing target control module 603. Alternatively, the reduced minimum separation time may be less than the minimum separation time according to the requirements of the existing target control module 603.

According to an embodiment, in 650, the gateway control module 602 may route the data frame to the target control module 603 at the reduced minimum separation time.

Referring to FIG. 6 according to an embodiment, the apparatus for controlling communication 601 may reduce the minimum separation time according to a low communication load ratio, and the gateway control module 602 may route data frames at the decreased minimum separation time. Thus, data frames may be faster.

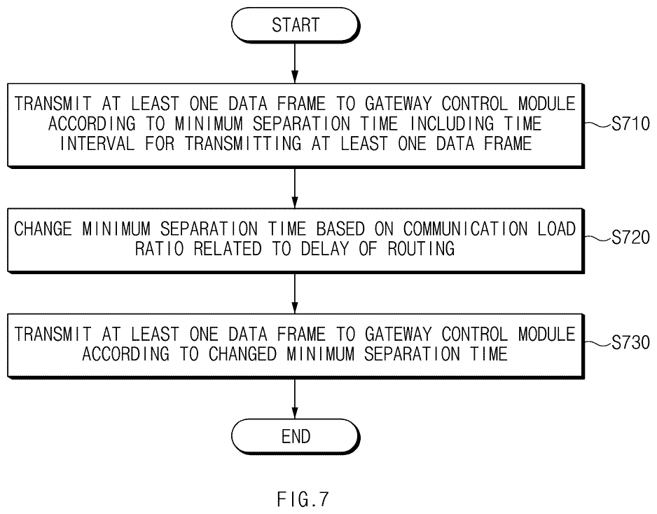

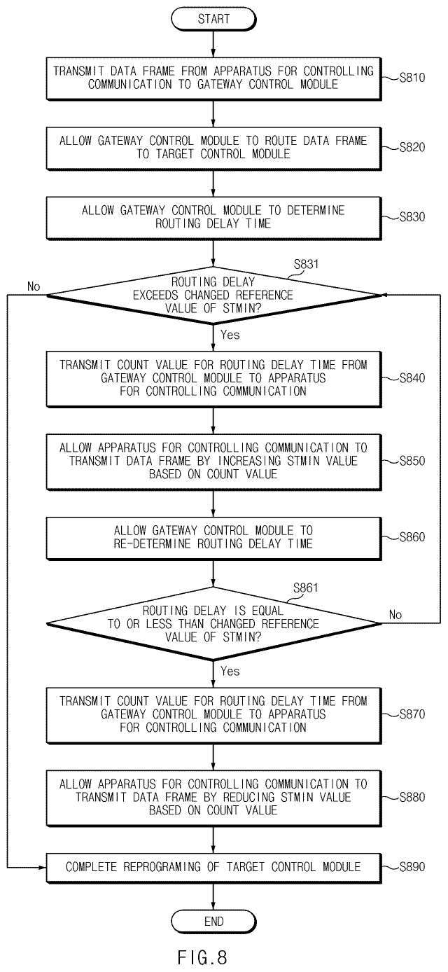

Hereinafter, methods for controlling communication according to embodiments of the present disclosure are described in detail with reference to FIGS. 7 and 8.

FIG. 7 is a flowchart illustrating a method for controlling communication according to an embodiment of the present disclosure.

In the following description of FIG. 7, it may be understood that the operations described as being performed by an apparatus for controlling communication are controlled by the processor 110 of the apparatus 100 for controlling communication.

According to an embodiment, in S710, an apparatus for controlling communication may transmit at least one data frame to a gateway control module according to a minimum separation time including a time interval for transmitting the at least one data frame.

According to an embodiment, in S720, the apparatus for controlling communication may change the minimum separation time based on a communication load ratio related to a delay of routing.

According to an embodiment, in S730, the apparatus for controlling communication may transmit the at least one data frame to the gateway control module according to the changed minimum separation time.

FIG. 8 is a flowchart illustrating that a method for controlling communication changes a minimum separation time according to a routing delay time according to an embodiment of the present disclosure.

According to an embodiment, in S810, an apparatus for controlling communication may transmit a data frame to a gateway control module. The data frame may include data frames obtained by dividing a large amount of original data. The data frame may include a data frame related to reprogramming.

According to an embodiment, in S820, the gateway control module may route a data frame to a target control module.

According to an embodiment, in S830, the gateway control module may determine the information about a delay including at least one of the number of times that routing of the data frame is delayed, the time for which the routing of the data frame is delayed, or any combination thereof in the process of routing the data frame to the target control module.

According to an embodiment, it may be determined in S831 whether the time for which routing is delayed exceeds a reference value for changing the minimum separation time (Stmin). This may be determined by the apparatus for controlling communication or by the gateway control module.

According to an embodiment, if the time for which routing is delayed exceeds a reference value for changing the minimum separation time (Yes in S831), in S840, the gateway control module may transmit, to the apparatus for controlling communication, a counting value for the time for which routing is delayed.

According to an embodiment, the apparatus for controlling communication may increase the minimum separation time based on the counting value. In S850, the apparatus for controlling communication may transmit a data frame to the gateway control module at the increased minimum separation time. The gateway control module may route data frames to the target control module at the increased minimum separation time.

According to an embodiment, in S860, the gateway control module may continuously re-determine at least one of the number of times that routing of the data frame is delayed, the time for which the routing of the data frame is delayed, or any combination thereof.

According to an embodiment, it may be determined in S861 whether the time for which routing is delayed is less than or equal to a reference value for changing a minimum separation time.

According to an embodiment, if the time for which routing is delayed is less than or equal to a reference value for changing the minimum separation time (Yes in S861), in S870, the gateway control module may transmit, to the apparatus for controlling communication, a counting value for the time for which routing is delayed.

According to an embodiment, the apparatus for controlling communication may reduce the minimum separation time based on the counting value. In S880, the apparatus for controlling communication may transmit a data frame to the gateway control module at the reduced minimum separation time. The gateway control module may route a data frame to the target control module at the reduced minimum separation time.

According to an embodiment, if the target control module receives all of the divided data frames, it is possible to configure the original data by reassembling the data frames. Accordingly, the reprogramming of the target control module may be completed in S890.

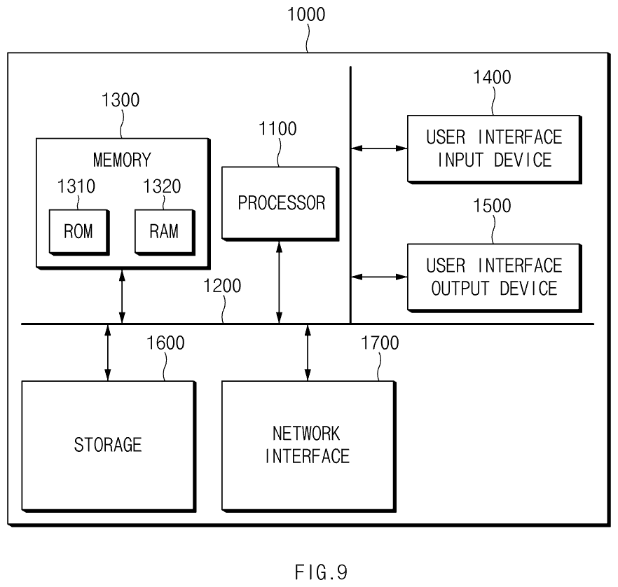

FIG. 9 is a diagram illustrating a computing system related to an apparatus, a system, and a method for controlling communication according to an embodiment of the present disclosure.

Referring to FIG. 9, a computing system 1000 may include at least one processor 1100, a memory 1300, a user interface input device 1400, a user interface output device 1500, a storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or any combination thereof. The software module may reside in a storage medium (i.e., the memory 1300 and/or the storage 1600), such as a RAM, a flash memory, a ROM, an EPROM, an EEPROM, a register, a hard disk, a detachable disk, or a CD-ROM.

The storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the present technology, it may be possible to prevent routing omission by changing the minimum separation time based on the communication load ratio related to the routing delay.

In addition, according to the present technology, it may be possible to determine whether there is a risk of routing omission by determining a communication load ratio through counting related to a routing delay.

In addition, according to the present technology, it may be possible to improve the success rate of updates by preventing failures in software updates that may occur due to a routing omission.

In addition, according to the present technology, it may be possible to increase efficiency in a test and evaluation process in a vehicle-related field by improving the success rate of software updates.

In addition, according to the present technology, it is possible to reduce the work time of a vehicle-related field by improving the success rate of software updates.

In addition, according to the present technology, it is possible to improve the efficiency of customer response service and after service (AS) maintenance by reducing the failure rate of controller updates using a diagnostic device in an AS center.

In addition, various effects that are directly or indirectly understood through the present disclosure may be provided.

Although embodiments of the present disclosure have been described for illustrative purposes, those having ordinary skill in the art should appreciate that various modifications, additions, and substitutions are possible, without departing from the scope and spirit of the present disclosure.

Therefore, the embodiments disclosed in the present disclosure are provided for the sake of descriptions and not for limiting the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the present disclosure.

What is claimed is:

1. A communication control apparatus, comprising:
a memory configured to store a program instruction; and
a processor configured, by executing the program instruction, to:
transmit at least one data frame to a gateway control module according to a minimum separation time including a time interval for transmitting the at least one data frame;
change the minimum separation time based on a communication load ratio related to a delay of routing; and
transmit the at least one data frame to the gateway control module according to the changed minimum separation time,
wherein original data is divided into the at least one data frame, and
wherein the gateway control module is configured to perform the routing.

2. The communication control apparatus of claim 1, wherein the communication load ratio increases as at least one of a time for which the routing is delayed, a number of times that the routing is delayed, or any combination thereof increases,
wherein the processor is configured to increase the minimum separation time based on the communication load ratio exceeding a first threshold value, and
wherein the first threshold value is set to a value at which routing of the at least one data frame is determined to be delayed.

3. The communication control apparatus of claim 2, wherein the processor is configured to reduce the increased minimum separation time based on the communication load ratio being less than or equal to a second threshold value after increasing the minimum separation time, and
wherein the second threshold value is set to a value equal to or less than the first threshold value.

4. The communication control apparatus of claim 1, wherein the processor is configured to determine the communication load ratio based on at least one of a number of times that routing of the at least one data frame is delayed, a time for which the routing of the at least one data frame is delayed, or any combination thereof, received from the gateway control module.

5. The communication control apparatus of claim 1, wherein the processor is configured to transmit the at least one data frame to the gateway control module based on at least one of the minimum separation time, a capacity of the at least one data frame, a number of the at least one data frame that is able to be transmitted at one time, a state of the communication control apparatus regarding whether transmission of the at least one data frame is possible, or any combination thereof.

6. The communication control apparatus of claim 1, wherein the processor is configured to transmit the at least one data frame to the gateway control module according to the minimum separation time of a controller area network (CAN) communication protocol.

7. The communication control apparatus of claim 1, wherein the processor is configured to change the minimum separation time based on a time taken for routing of the at least one data frame to be completed by the gateway control module.

8. A system for controlling communication, the system comprising:
a communication control apparatus configured to:
transmit at least one data frame to a gateway control module according to a minimum separation time; and
change the minimum separation time based on information about a delay,
the gateway control module configured to:
perform routing; and
transmit the information about the delay to the communication control apparatus based on the delay occurring in routing of the at least one data frame,
wherein original data is divided into the at least one data frame.

9. The system of claim 8, wherein the gateway control module is configured to identify the information about the delay including at least one of a number of times that routing of the at least one data frame is delayed, a time for which the routing of the at least one data frame is delayed, or any combination thereof, based on the delay occurring in the routing of the at least one data frame.

10. The system of claim 8, wherein the gateway control module is configured to repeatedly transmit the information about the delay to the communication control apparatus at a preset cycle until the routing of the at least one data frame included in the data is completed.

11. The system of claim 8, wherein the communication control apparatus is configured to:
determine a communication load ratio based on information about the delay of the routing; and
increase the minimum separation time based on the communication load ratio exceeding a first threshold value, and
wherein the first threshold value is set to a value at which routing of the at least one data frame is determined to be delayed.

12. The system of claim 8, further comprising:
a target control module configured to receive the at least one data frame from the gateway control module,
wherein the gateway control module is configured to:
transmit a disable normal message transmission (DNMT) message for deactivating normal transmission of a message to the target control module; or
transmit an enable normal message transmission (ENMT) message for activating normal transmission of the message to the target control module.

13. The system of claim 8, further comprising:
a target control module configured to receive the at least one data frame from the gateway control module,
wherein the target control module is configured to transmit information about the minimum separation time according to requirements of the target control module to the communication control apparatus, and
wherein the communication control apparatus is configured to transmit the at least one data frame to the gateway control module based on the information about the minimum separation time.

14. A method of controlling communication, the method comprising:
transmitting, by a processor, at least one data frame to a gateway control module according to a minimum separation time including a time interval for transmitting the at least one data frame;
changing, by the processor, the minimum separation time based on a communication load ratio related to a delay of routing; and
transmitting, by the processor, the at least one data frame to the gateway control module according to the changed minimum separation time.

15. The method of claim 14, wherein changing the minimum separation time includes increasing, by the processor, the minimum separation time based on the communication load ratio exceeding a first threshold value, and
wherein the first threshold value is set to a value at which routing of the at least one data frame is determined to be delayed.

16. The method of claim 15, wherein changing the minimum separation time includes reducing, by the processor, the increased minimum separation time based on the communication load ratio being less than or equal to a second threshold value after increasing the minimum separation time, and
wherein the second threshold value is set to a value equal to or less than the first threshold value.

17. The method of claim 14, further comprising:
determining, by the processor, the communication load ratio based on at least one of a number of times that routing of the at least one data frame is delayed, a time for which the routing of the at least one data frame is delayed, or any combination thereof, received from the gateway control module.

18. The method of claim 14, wherein changing the minimum separation time includes transmitting, by the processor, the at least one data frame to the gateway control module based on at least one of the minimum separation time, a capacity of the at least one data frame, a number of the at least one data frame that is able to be transmitted at one time, a state of a communication control apparatus regarding whether transmission of the at least one data frame is possible, or any combination thereof.

19. The method of claim 14, wherein changing the minimum separation time includes transmitting, by the processor, the at least one data frame to the gateway control module according to the minimum separation time of a controller area network (CAN) communication protocol.

20. The method of claim 14, wherein changing the minimum separation time includes changing, by the processor, the minimum separation time based on a time taken for routing of the at least one data frame to be completed by the gateway control module.
